(19) United States
(12) Patent Application Publication
(10) Pub. No.: US 2020/0134958 A1
(43) Pub. Date: Apr. 30, 2020

(54) DEVICE FOR RECEIVING COINS OR TOKENS FOR A PAYMENT TERMINAL

(71) Applicant: FLOWBIRD, PARIS (FR)

(72) Inventors: Sylvain BRAUN, OSSELLE-ROUTELLE (FR); Jérôme BUHON, ECHAY (FR)

(21) Appl. No.: 16/623,933

(22) PCT Filed: Jun. 20, 2018
(86) PCT No.: PCT/EP2018/066484

§ 371 Date: Dec. 18, 2019

(30) Foreign Application Priority Data
Jun. 20, 2017 (FR) 17 55588

(51) Int. Cl. G07F 1/04; G07D 11/14; G07D 11/225

(52) U.S. Cl. CPC G07F 1/043; G07F 1/047; G07D 11/225; G07D 11/14

(57) ABSTRACT

Disclosed is a receiving device which includes a passage for the circulation of a coin or a token, and an anti-fraud system including at least two attachment elements, each attachment element being configured to be capable of attaching to a flexible threadlike link engaging with the attachment element, the attachment elements being mounted so as to rotate about an axis of rotation following a circular path passing through the passage so that each attachment element can come into contact with and attach to a flexible threadlike link fastened to a coin or a token circulating in the passage, the attachment elements being angularly spaced apart around the axis of rotation.

### BACKGROUND OF THE INVENTION

### Field of the Invention

The present invention relates to the field of payment terminals for making payment with coins or tokens.

### Description of the Related Art

A common method of fraud currently used in coin or token payment terminals is to attach a coin or a token to one end of a wire or filament before introducing the coin or token into the payment terminal through an object introduction slot provided for this purpose.

In the case of a parking lot payment terminal, this method of fraud allows the fraud perpetrator to obtain a parking authorisation for free for a period corresponding to the payment amount of the coin introduced.

In order to avoid such fraud, the document FR2993692A1 provides a payment terminal equipped with a pre-payment receiving device whose inlet comprises a cutting blade that is used for cutting a wire that would be connected to a coin received in the pre-payment receiving device.

### SUMMARY OF THE INVENTION

An object of the invention is to provide a payment receiving device for receiving coins or tokens for a payment terminal, which effectively serves to limit fraud in the use of the payment terminal.

To this end, the invention proposes a payment receiving device for receiving coins or tokens for a payment terminal, comprising a passage for the through-movement of a coin or a token, and an anti-fraud system comprising at least two attachment elements, each attachment element being configured so as to be capable of attaching to a flexible filiform tie that comes into contact with the attachment element, the attachment elements being mounted so as to be movable about an axis of rotation along a circular trajectory passing through the passage in a manner such that each attachment element is able to come into contact with, and attach to a flexible filiform tie that is fastened to a coin or a token moving along in the passage, the attachment elements being angularly spaced apart around the axis of rotation.

The attachment elements rotating about an axis of rotation and angularly distributed about the axis of rotation are able hook on and attach to a flexible filiform tie such as a wire attached to a coin, and wind it around the attachment elements, during the through-movement of the coin or token within the passage. The attachment elements are able to hook on and attach to the flexible filiform tie in a reliable and efficient manner, thereby preventing the coin or token from being fraudulently retrieved.

In particular embodiments, the payment receiving device may comprise one or more of the following optional characteristic features, taken into consideration individually or in accordance with any technically possible combinations:
it comprises a drive device arranged in order for driving the attachment elements around the axis of rotation;
the attachment elements are distributed over the same imaginary circle centred on the axis of rotation;
the attachment elements are borne by a support piece mounted so as to be movable about the axis of rotation;
it comprises a wheel mounted so as to be rotatable in the interior of the passage, the wheel being provided with at least one housing adapted so as to receive a coin or a token inserted into an inlet of the passage and to move the coin along towards an outlet of the passage by virtue of the rotation of the wheel;
the wheel comprises through openings located radially between a hub and a peripheral surface of the wheel, the attachment elements being located in the openings;
the attachment elements are borne by the wheel that forms a support piece for the attachment elements or by a distinct support piece that is separate from the wheel, coaxial with the wheel, and integrally joined in rotation with the wheel;
each attachment element comprises at least one notch and/or at least one hook for hooking so as to attach to a filiform tie;
each attachment element comprises at least one notch on the interior of which is disposed at least one hook;
It comprises a payment detection device that includes at least one sensor disposed along the passage so as to check the validity of a coin or a token moving along in the passage;
at least one of the said attachment elements is configured so as to cut a filiform tie.

The invention also relates to a payment terminal comprising a payment receiving device as defined here above.

### BRIEF DESCRIPTION OF THE DRAWINGS

The invention and its advantages will be better understood upon reading the description which will follow, given solely by way of example, and with reference made to the appended drawings, in which:

FIGS. 1 to 3 are schematic views of a payment terminal comprising a payment receiving device for receiving coins or tokens in various different configurations;

FIG. 4 is a schematic view in perspective of a wheel and an anti-fraud system of the payment receiving device shown in FIG. 1, the anti-fraud system comprising the attachment elements;

FIGS. 5 and 6 are front views of the face of the attachment elements of the anti-fraud system; and

FIG. 7 is a view analogous to that shown in FIG. 1, illustrating a payment receiving device provided with an anti-fraud system according to one variant embodiment.

### DETAILED DESCRIPTION OF THE PREFERRED EMBODIMENTS

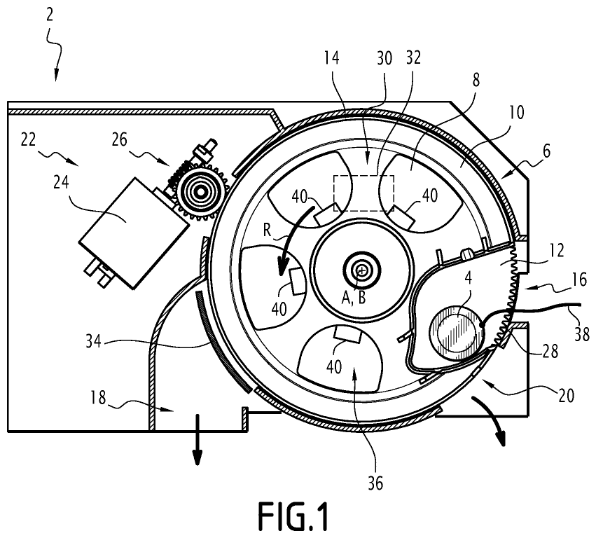

The payment terminal 2 shown in FIGS. 1 to 3 makes it possible to make a payment using one or more coins 4 or one or more tokens. The description that follows refers to a coin but could apply as well to a token.

The payment terminal 2 equips for example a device for purchasing a product and/or a service, such as a product dispensing machine, a vending machine for transportation/travel tickets and fares, a parking ticket dispensing machine, a gaming machine or a gambling slot machine.

The payment terminal 2 has a payment receiving device 6 configured so as to receive the coins 4.

The payment receiving device 6 comprises a passage 8 for the through-movement of a coin 4 introduced into the payment receiving device 6.

The payment receiving device 6 comprises a wheel 10 that is disposed in the interior of the passage 8 in order to control the through-movement of a coin 4 in the passage 8. The wheel 10 is mounted so as to be rotatable about its central axis A.

The wheel 10 has a housing 12 that is adapted so as to receive a coin 4 and capable of moving along the coin 4 in the passage 8 by means of rotation of the wheel 10 about its central axis A. When it comes to be controlled by the wheel 10, the coin 4 follows substantially an arcuate path centred on the central axis A of the wheel 10.

The housing 12 opens on to a circumferential surface 14 of the wheel 10 in order to enable the entry of the coin 4 into the housing 12 and the exit of the coin 4 out of the housing 12.

The passage 8 comprises one inlet 16 for a coin 4 and at least one outlet 18, 20 for the coin 4, here two outlets 18, 20. The inlet 16 and the at least one outlet 18, 20 are distributed around the wheel 10 while being angularly spaced apart.

The rotation of the wheel 10 makes it possible to position the housing 12 to be facing selectively the inlet 10, so as to receive a coin 4, or an outlet 18, 20 so as to release the coin into the outlet 18, 20 that is situated to be facing the housing 12.

The payment receiving device 6 comprises a drive device 22 configured so as to drive the wheel 10 in rotation around its central axis A.

The drive device 22 here comprises a motor 24 that drives the wheel 10 by means of a transmission gear 26 in engagement with a toothing 28 located on the peripheral surface 14 of the wheel 10.

The payment receiving device 6 is configured for enabling the rotation of the wheel 10 about its central axis A in a single direction of rotation, illustrated by the arrow R in FIGS. 1 to 3.

During the course of rotation of the wheel 10 in the single direction of rotation, the housing 12 is moved along successively so as to be facing the inlet 16 and then each of the outlets 18, 20 until returning to the position of again facing the inlet 16.

In the example illustrated, the payment receiving device 6 is configured so as to accept valid coins 4 and reject coins 4 that are not valid.

The payment receiving device 6 comprises a payment detection device 30 for detecting the validity of a coin 4 inserted into the payment receiving device 6.

The payment detection device 30 comprises at least one sensor 32 that is used to check and verify the validity of the coin 4. In a manner known per se, the sensor 32 is for example an optical sensor or a magnetic sensor.

The sensor 32 is disposed on the side of the wheel 10, in a manner such that the housing 12 that receives the coin 4 passes in front of the sensor 32 during the rotation of the wheel 10, between the inlet 16, on the one hand, and the outlets 18, 20, on the other hand.

The selection device 6 comprises a shutter 34 controlled by the payment detection device 30, for selectively closing or opening the first outlet 18 in front of which the housing 12 passes during the rotation of the wheel 10, depending on whether the coin 4 received in the housing 14 is valid or not.

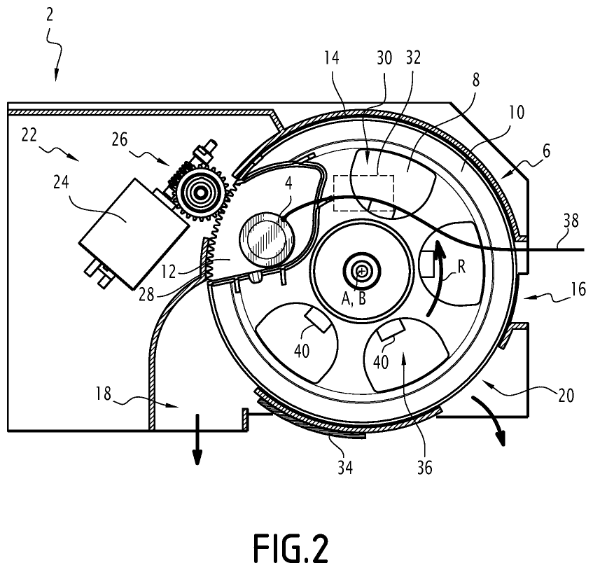

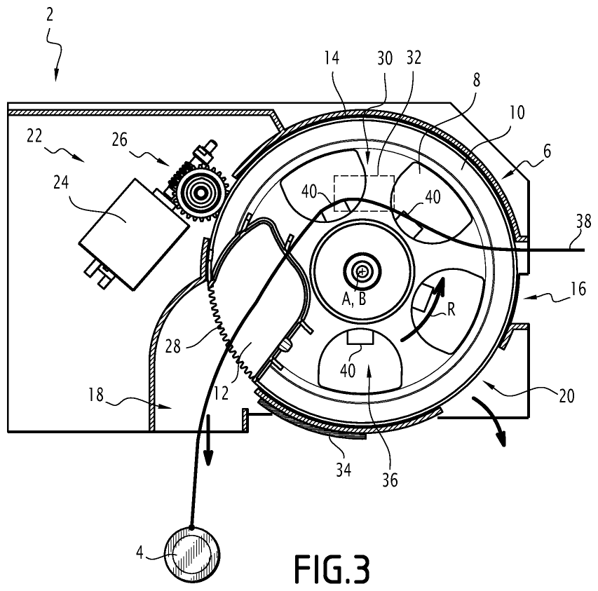

The shutter 34 is movable between a closed position illustrated in FIG. 1, in which it prevents the passage of the coin 4 into the first outlet 18, and an open position illustrated in FIGS. 2 and 3 in which it opens up the first outlet 18 in order to allow the passage of the coin 4.

When the shutter 34 is opened to the passage of the housing 12, the coin 4 falls into the first outlet 18. When the shutter 34 remains closed to the passage of the housing 12, the coin falls into the second outlet 20.

The first outlet 18 in front of which the housing 12 passes during the rotation of the wheel 10 is here a payment collection outlet for valid coins, that is in communication with a money box, and the second outlet 20 is a return outlet that is in communication with a receptacle that serves to enable recovery of the rejected coin 4.

By way of a variant, the first outlet 18 is here a return outlet and the second outlet 20 is a payment collection outlet.

The payment receiving device 6 comprises an anti-fraud system 36 making it possible to block a fraudulent act in which a flexible thread like tie 38 is attached to a coin 4 and used to retain hold of this coin 4 for retrieval from the exterior of the payment receiving device 6.

The anti-fraud system 36 includes at least two attachment elements 40, each attachment element 40 being configured so as to be capable of attaching to a thread like tie 38 that comes into contact with the attachment element 40.

The attachment elements 40 are mounted so as to be movable about an axis of rotation B, each attachment element 40 following a circular trajectory centred on the axis of rotation B and passing through the passage 8, in a manner such that each attachment element 40 is able to come into contact with, and hook so as to attach to a thread like tie 38 fastened to a coin 4 moving along in the passage 8.

The attachment elements 40 are angularly spaced apart around the axis of rotation B. The attachment elements 40 are in turn able to come into contact with, and hook so as to attach to a thread like tie 38 that is fastened to a coin 4 moving along in the passage 8.

In FIGS. 1 to 3, the axis of rotation B coincides with the central axis A, the attachment elements 40 mounted so as to be movable circularly around the central axis A.

The attachment elements 40 are here integrally secured to the wheel 10 and rotate around the central axis A together with the wheel 10.

The attachment elements 40 follow the same path as the coin 4, while passing behind the latter. Thus, the attachment elements 40 are able to come into contact with the thread like tie 38 so as to hook and attach to it and cause it to be wound around the attachment elements 40.

The attachment elements 40 here are distributed angularly about the axis of rotation B while being situated on the same imaginary circle C.

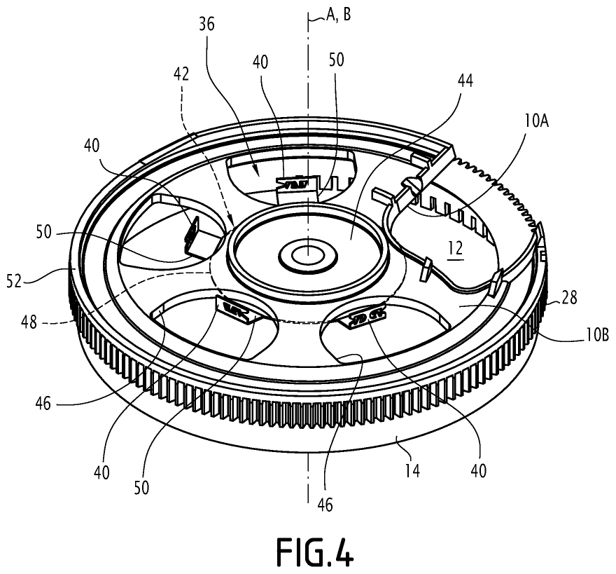

As can be seen in FIG. 4, each attachment element 40 is located radially between a hub 44 of the wheel 10 and the peripheral surface 14 of the wheel 10. The attachment elements 40 are for example situated at a distance from the central axis A of the wheel 10 measuring between 25% and 75% of the outer diameter of the wheel 10. Thus, the attachment elements 40 are situated radially on the path followed by the coin 4 that comes to be controlled by the wheel 10, along which the thread like tie 38 is likely to be located.

The attachment elements 40 are borne by a distinct support piece 42 that is separate from the wheel 10. The support piece 42 is coaxial with the wheel 10. The support piece 42 is integrally joined in rotation with the wheel 10 around the axis of rotation B. The support piece 42 and the wheel 10 rotate together.

The wheel 10 comprises through openings 46 located radially between the hub 44 and the peripheral surface 14 of the wheel, the attachment elements 40 being located in these openings 46.

The wheel 10 has a first lateral surface 10A and a second lateral surface 10B opposite therefrom. The openings 46 extend between the first lateral surface 10A and the second lateral surface 10B.

The support piece 42 comprises a disc-shaped central portion 48 and arms 50 that extend radially from the central portion 48 towards the exterior, each arm 48 bearing at its free end away from the central portion 48 a respective attachment element 40.

The support piece 42 is arranged on the side of the first lateral surface 10A of the wheel 10, and the attachment elements 40 extend to the second lateral surface 10B by passing through the openings 46.

The wheel 10 is provided with, on the lateral edge of its peripheral surface 14 located on the side of the second lateral surface 10B, a peripheral rim arranged with a circumferential recess 52.

This recess 52 makes it possible to guide a thread like tie 38 fastened to a coin 4 that comes to be controlled by the wheel 10 in order to ensure that the thread like tie 38 passes over the side of the wheel 10, on the side of the second lateral surface 10B where the attachment elements 40 are located.

Thus, the thread like tie 38 does not wind around the peripheral surface 14 of the wheel 10, but passes alongside the wheel 10, in a manner such that it can join the path followed by the coin 4 that comes to be controlled by the wheel 10 and be hooked by the attachment elements 40.

Each attachment element 40 is configured to be able to hook and attach to a thread like tie 38 that comes into contact with the attachment element 40. In particular, each attachment element 40 is configured so as to come into contact with the thread like tie 38 by inducing a change of direction of the thread like tie 38, thereby preventing the fraudulent retraction of the thread like tie 38.

Each attachment element 40 is for example configured so as to come into contact with the thread like tie 38 by a portion that is provided with a notch adapted so as to receive the thread like tie 38 and/or by a portion in the form of a hook provided so as to hook the thread like tie 38.

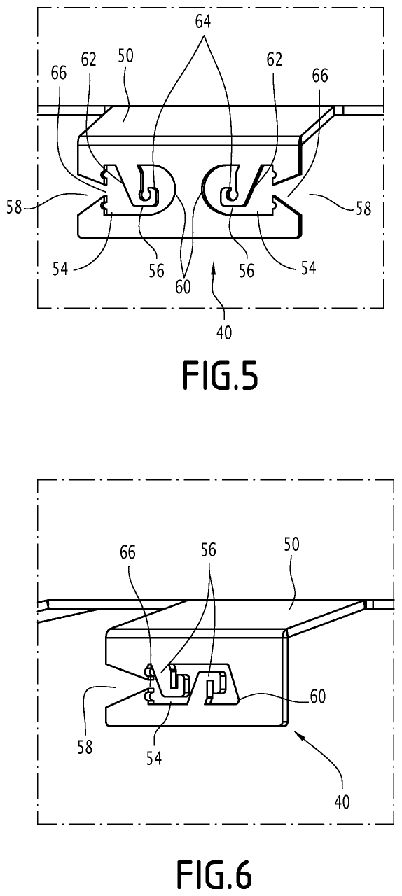

As illustrated in FIGS. 5 and 6, which illustrate examples of attachment elements, each attachment element 40 may for example comprise a notch 54 and/or a hook 56 provided in order for engaging a filiform tie 38 that comes into contact with the attachment element 40.

An attachment element 40 may in particular comprise a notch 54 and at least one hook 56 disposed on the interior of the notch 54 in order to counter and disable the removal of a thread like tie 38 which would have been introduced into the notch 54.

The attachment element 40 illustrated in FIG. 5 comprises two notches 54 with a corresponding hook 56 respectively disposed on the interior of each notch 54 in order to prevent a thread like tie 38 that has entered into the notch 36 from being removed therefrom. Each hook 56 extends toward the interior of the corresponding notch 54 from an internal edge of this notch 54.

Each notch 54 has an inlet 58 opening on to an edge of the attachment element 40 and a bottom 60.

Each hook 56 has an inclined edge 62 on the inlet side 58 and a curved end 64 on the bottom side 60. The inclined edge 62 is inclined in a manner so as to facilitate the passage of a thread like tie 38 from the inlet 58 to the bottom 60. The curved end 64 is curved in a manner so as to prevent the return of the filiform element 38 from the bottom 60 to the inlet 58.

Each notch 34 may have a constriction 66 between the inlet 58 and the bottom 60 of the notch 34. This promotes the retaining of the filiform tie 38 on the interior of the notch 34. The or each hook 38 disposed in the notch 34 is disposed between the constriction 66 and the bottom 60 of the notch 34.

The attachment element 40 shown in FIG. 5 comprises two notches 54, each provided with an internal hook 56, the notches 54 opening on two opposite edges of the attachment element 40, here a front edge and a rear edge of the attachment element 40 considering the direction of movement of the attachment element 40 about the axis of rotation B.

In one variant embodiment, an attachment element 40 comprises a single notch 54. In this case, the inlet 40 of the notch 54 is preferably located on a front edge of the attachment element 40.

The attachment element 40 shown in FIG. 6 differs from that shown in FIG. 5 in that it comprises a notch 54 on the interior of which two hooks 56 are arranged, one behind the other in a manner so as to define a twisting or zigzag path between the inlet 58 and the bottom 60 of the notch 54. The hooks 56 extending alternately from a first lateral internal edge and a second opposite lateral internal edge of the notch 54.

In one variant embodiment, the attachment element 40 comprises more than two hooks 56 arranged one behind the other in a manner so as to define a twisting or zigzag path between the inlet 58 and the bottom 60 of the notch 54.

The operation of the payment receiving device 6 is described here below with reference to FIGS. 1 to 6.

Initially, the wheel 10 is oriented in a stand-by angular position in which the housing 12 is positioned to be facing the inlet 16.

In a first step, a user introduces a coin 4 into the payment terminal 2 through the inlet 16. The coin 4 falls into the housing 16, as shown in FIG. 1.

The drive device 22 drives the wheel 10 in rotation in the direction of the arrow R. The housing 12 begins by moving from the inlet 16 to the payment collection outlet 18 by passing in front of the sensor 32 of the payment detection device 30 as is visible in FIG. 2.

If the coin 4 is valid, the detection device 30 commands the moving of the shutter 34 into the open position. When the housing 12 arrives in position so as to be facing the payment collection outlet 18, the coin 4 falls through the payment collection outlet 18.

If on the contrary, the coin 4 is not valid, the payment detection device 30 commands the maintaining of the shutter 34 in the closed position. The coin 4 does not fall into the payment collection outlet 18 on account of the closure of the shutter 34, and instead falls into the return outlet 20 when the housing 12 arrives in position so as to be facing the latter.

If the coin 4 is fastened to the end of a filiform tie 38, the filiform tie 38 tends to follow the coin 4 along the path taken by the latter. The recess 52 serves as the means to let the filiform tie 38 pass over the side of the wheel 10, towards the path followed by the coin 4 that comes to be controlled by the wheel 10, without it winding around the peripheral surface 14 of the wheel 10.

The attachment elements 40 rotate together with the wheel 10. Due to this rotation, the attachment elements 40 pass over the path followed by the coin 4 and interfere with the filiform tie 38 which is following the coin 4. The filiform tie 38 tends to get hooked on to the attachment elements 40 and to be wound around them by virtue of the rotating thereof. As a result thereof, the filiform tie 38 becomes entangled with the attachment elements 40, which prevents the fraud perpetrator from being able to retain hold of the coin 4.

The attachment elements 40 angularly spaced apart around the axis of rotation B come into contact with a filiform tie 38 one after the other, which increases the chances of successful hooking-attachment and/or increases the number of points of hooking-attachment of the filiform tie 38, thus ensuring effective and reliable attachment.

If the fraud perpetrator introduces one or more coins after the one fastened to a filiform tie 38, the attachment elements 40 continue to rotate about the axis of rotation B and the filiform tie 38 continues to get wound even further around the attachment elements 40.

Thus, the anti-fraud device 8 makes it possible to hinder or block the fraudulent act by causing the winding of a filiform tie 38 fastened to a coin 4 around attachment elements 40, thereby preventing a fraud perpetrator from being able to retain hold of the coin 4 by means of the filiform tie 38.

Moreover, depending on the nature of the filiform tie 38, the filiform tie 38 is very likely to be cut by one of the attachment elements 40. Indeed, due to the tension of the filiform tie 38 resulting from the retaining force exerted on the filiform tie 38 and the driving of the filiform tie 38 by one or more attachment elements 40, the filiform tie 38 can be cut, for example against an edge of an attachment element 40.

The anti-fraud system 36 is located within the interior of the payment terminal 2. It is neither visible nor accessible from the exterior of the payment terminal 2, which thus renders difficult the neutralisation or circumvention thereof by a user.

The anti-fraud system 36 is here integrated within a payment receiving device 6 forming a money/coin selector, in which the validity of the coins 4 is checked and verified during the course of the coins 4 coming to be controlled by the wheel 10.

In the example of embodiment shown in FIGS. 1 to 4, the attachment elements 40 are borne by a distinct support piece 42 that is separate from the wheel 10. This provides the means to easily adapt an existing payment receiving device 6 by simply incorporating the support piece 42 provided with attachment elements 40 on to the wheel 10.

In one variant embodiment, the attachment elements 40 are fixed on to the wheel 10 or integrally formed as one piece with the wheel 10. The wheel 10 then defines a support piece that bears the attachment elements 40.

In a general manner, the attachment elements 40 are borne by the same support piece mounted so as to be rotatable about the axis of rotation B in a manner such that each attachment element 40 is movable along a circular trajectory that is centred on the axis of rotation B during the rotation of the support piece, the circular trajectory passing at least in part through the passage 8 such that the attachment elements 40 are able to come into contact with, so as to hook and attach to a filiform tie that is fastened to a coin.

In the example of embodiment shown in FIGS. 1 to 4, the attachment elements 40 are integrally secured to a wheel 10 that controls the through-movement of a coin in the passage 8. Furthermore, the circular trajectory of the attachment elements 40 is entirely located in the interior of the passage 8.

The anti-fraud system 36 is not necessarily associated with a wheel 10 that controls the through-movement of a coin 4 in the passage 8 in the manner of a turnstile. Moreover, the circular trajectory of the attachment elements 40 is not necessarily entirely located in the interior of the passage 8.

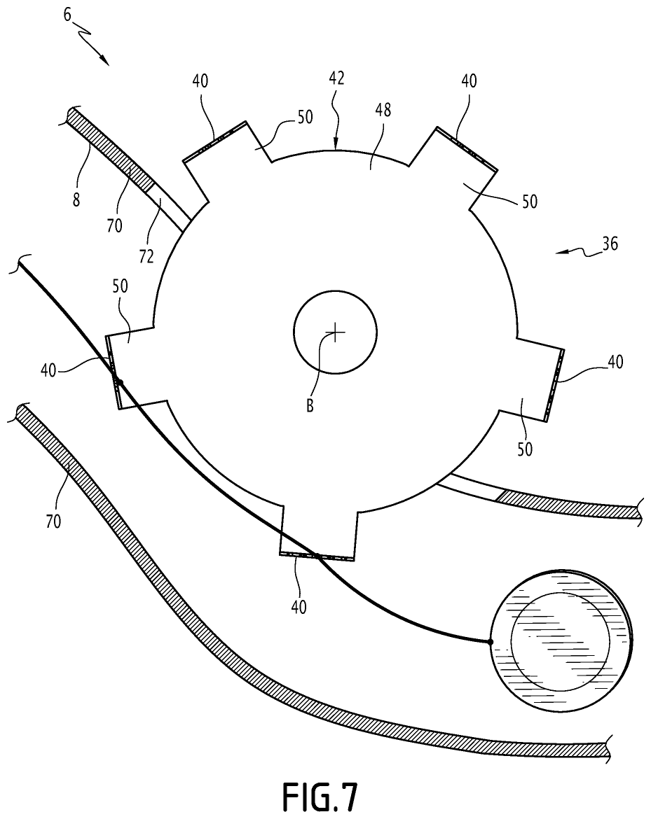

The payment receiving device 6 illustrated in FIG. 7 comprises a passage 8 and an anti-fraud system 36 comprising the attachment elements 40 mounted so as to be movable circularly around the axis of rotation B along a circular trajectory passing through the passage 8 in order to interfere with a filiform tie 38 fastened to a coin.

One part of the circular trajectory is situated in the passage 8 and another part of the circular trajectory is situated on the exterior of the passage 8.

The passage 8 is delimited by two lateral walls 70, one of the lateral walls having an opening 72 through which the attachment elements 40 enter and exit the passage 8.

The attachment elements 40 are borne by a support piece 42 mounted so as to be rotatable about the axis of rotation B. The support piece 42 is mounted on the side of the passage 8, with a portion of the support piece 42 being situated on the exterior of the passage 8.

The support piece 42 has a disc-shaped central portion 48 and arms 50 that extend radially from the central portion 48 and bear the attachment elements 40.

The support piece 42 is not configured to control the through-movement of a coin in the passage 8.

The anti-fraud system 36 comprises for example a drive device for driving the support piece 42 in rotation. By way of a variant, the support piece 42 is mounted so as to be rotatable freely about the axis of rotation B. It is set to begin rotating upon the passage of a coin 4.

1-12. (canceled)

13. A payment receiving device for receiving coins or tokens for a payment terminal, comprising a passage for the through-movement of a coin or a token, and an anti-fraud system comprising at least two attachment elements, each attachment element being configured so as to be capable of attaching to a flexible filiform tie that comes into contact with the attachment element, the attachment elements being mounted so as to be movable about an axis of rotation along a circular trajectory passing through the passage in a manner such that each attachment element is able to come into contact with, and attach to a flexible filiform tie that is fastened to a coin or a token moving along in the passage, the attachment elements being angularly spaced apart around the axis of rotation.

14. A payment receiving device according to claim 13, comprising a drive device arranged in order for driving the attachment elements about the axis of rotation.

15. A payment receiving device according to claim 13, wherein the attachment elements are distributed over the same imaginary circle centred on the axis of rotation.

16. A payment receiving device according to claim 13, wherein the attachment elements are borne by a support piece mounted so as to be movable about the axis of rotation.

17. A payment receiving device according to claim 13, comprising a wheel mounted so as to be rotatable in the interior of the passage, the wheel being provided with at least one housing adapted so as to receive a coin or a token inserted into an inlet of the passage and to move the coin along towards an outlet of the passage by virtue of the rotation of the wheel.

18. A payment receiving device according to claim 17, wherein the wheel comprises through openings located radially between a hub and a peripheral surface of the wheel, the attachment elements being located in the openings.

19. A payment receiving device according to claim 17, wherein the attachment elements are borne by the wheel that forms a support piece for the attachment elements or by a distinct support piece that is separate from the wheel, coaxial with the wheel and integrally joined in rotation with the wheel.

20. A payment receiving device according to claim 13, wherein each attachment element comprises at least one notch and/or at least one hook for hooking so as to attach to a filiform tie.

21. A payment receiving device according to claim 20, wherein each attachment element comprises at least one notch on the interior of which is disposed at least one hook.

22. A payment receiving device according to claim 13, comprising a payment detection device that includes at least one sensor disposed along the passage so as to check the validity of a coin or a token moving along in the passage.

23. A payment receiving device according to claim 13, wherein at least one of the said attachment elements is configured so as to cut a filiform tie.

24. A payment terminal comprising a payment receiving device according to claim 13.

25. A payment receiving device according to claim 14, wherein the attachment elements are distributed over the same imaginary circle centred on the axis of rotation.

26. A payment receiving device according to claim 14, wherein the attachment elements are borne by a support piece mounted so as to be movable about the axis of rotation.

27. A payment receiving device according to claim 15, wherein the attachment elements are borne by a support piece mounted so as to be movable about the axis of rotation.

28. A payment receiving device according to claim 14, comprising a wheel mounted so as to be rotatable in the interior of the passage, the wheel being provided with at least one housing adapted so as to receive a coin or a token inserted into an inlet of the passage and to move the coin along towards an outlet of the passage by virtue of the rotation of the wheel.

29. A payment receiving device according to claim 15, comprising a wheel mounted so as to be rotatable in the interior of the passage, the wheel being provided with at least one housing adapted so as to receive a coin or a token inserted into an inlet of the passage and to move the coin along towards an outlet of the passage by virtue of the rotation of the wheel.

30. A payment receiving device according to claim 16, comprising a wheel mounted so as to be rotatable in the interior of the passage, the wheel being provided with at least one housing adapted so as to receive a coin or a token inserted into an inlet of the passage and to move the coin along towards an outlet of the passage by virtue of the rotation of the wheel.

31. A payment receiving device according to claim 18, wherein the attachment elements are borne by the wheel that forms a support piece for the attachment elements or by a distinct support piece that is separate from the wheel, coaxial with the wheel and integrally joined in rotation with the wheel.

32. A payment receiving device according to claim 14, wherein each attachment element comprises at least one notch and/or at least one hook for hooking so as to attach to a filiform tie.
